(19) United States
(12) Patent Application Publication
(10) Pub. No.: US 2025/0153654 A1
(43) Pub. Date: May 15, 2025

(54) DIGITAL REAR MIRROR DEVICE WITH IMPROVED USABILITY

(71) Applicant: THINKWARE CORPORATION, Seongnam-si (KR)

(72) Inventors: Tae Jin KIM, Seongnam-si (KR); Soon Woo PARK, Seongnam-si (KR); Ho Kwan LEE, Seongnam-si (KR); Hyun Chul CHO, Seongnam-si (KR); Sung Rak CHOI, Seongnam-si (KR)

(21) Appl. No.: 18/897,550

(22) Filed: Sep. 26, 2024

(30) Foreign Application Priority Data
Sep. 27, 2023 (KR) 10-2023-0130798
Sep. 27, 2023 (KR) 10-2023-0130815
Oct. 6, 2023 (KR) 10-2023-0133376
Nov. 27, 2023 (KR) 10-2023-0166896
Sep. 26, 2024 (KR) 10-2024-0131052

(51) Int. Cl. B60R 11/02; B60R 1/04; B60R 1/26; B60R 1/29; B60R 11/00; G06V 20/56; G06V 20/59; G06V 40/18

(52) U.S. Cl. CPC B60R 11/0235; B60R 1/04; B60R 1/26; B60R 1/29; G06V 20/56; G06V 20/59; G06V 40/18; B60R 2011/0033; B60R 2011/0084; B60R 2011/0085; B60R 2011/0092; B60R 2300/802; B60R 2300/8066

(57) ABSTRACT

A digital rear mirror device with improved usability according to exemplary embodiments of the present disclosure may include a rear mirror display unit that is installed in an internal space of a vehicle and implements a mirror mode checking a rear space of the vehicle through reflection or refraction of light, and an LCD mode outputting an image or video, a sensor unit that that detects interior and exterior environments of the vehicle, a driving mode switching unit that selectively drives one of the mirror mode and the LCD mode, and a control unit that controls driving of the rear mirror display unit, in which the rear mirror display unit may be controlled to track a user's gaze through the sensor unit so that a direction of a screen faces an area where a user is located.

### CROSS-REFERENCE TO RELATED APPLICATIONS

This application claims benefit of priority to Korean Patent Application Nos. 10-2023-0130798, filed Sep. 27, 2023; 10-2023-0130815, filed Sep. 27, 2023; 10-2023-0133376, filed Oct. 6, 2023; 10-2023-0166896, filed Nov. 27, 2023; and 10-2024-0131052, filed Sep. 26, 2024; the disclosure of each of which are incorporated herein by reference in their entirety.

### TECHNICAL FIELD

The present disclosure relates to a digital rear mirror device with improved usability, and more particularly, to a digital rear mirror with improved usability by controlling a direction of a screen to automatically match and face a user's gaze in a state where an LCD mode in which images or videos are streamed is implemented, in which the digital rear mirror device can be switched between a mirror mode and the LCD mode.

### TECHNOLOGY BACKGROUND OF THE INVENTION

Existing rear mirrors are a method of checking situations behind a vehicle through a mirror, and a driver may understand situations by looking at a rear view reflected in a rear mirror. Since an angle of the rear mirror is fixed as set by a driver depending on a size and position of a driver's body, the rear view may only be checked only at a specific angle.

In addition, since the rear view may only be checked as much as an area of the mirror, the view that may be checked is inevitably limited, and blind spots that the driver cannot directly check with his/her eyes may occur, which may increase the risk of an accident. In addition, since there is the inconvenience of having to manually adjust the rear mirror while driving, the driver's attention may be distracted and thus safe driving may be hindered.

On the other hand, to solve these problems, a digital rear mirror may display images in real time on a digital screen using a camera installed at the rear of the vehicle. This technology, which replaces the existing rear mirrors, makes it much easier for a driver to check situations behind a vehicle and a condition of a road, and even identifies blind spots that are difficult to identify with the rear mirrors.

However, since the images output from the digital rear mirror may differ from the mirror in an actual field of vision and a sense of depth or a viewing angle of a screen compared to the mirror, drivers may have difficulty adapting to this situation, and when looking at a fast-moving object on a digital screen, slight delay or image distortion may occur.

In addition, when a driver should manually operate the images output from the digital rear mirror while driving, the driver's attention may be distracted, which may lead to a risk of an accident.

### CONTENTS OF THE INVENTION

### Problems to be Solved

The present disclosure provides a digital rear mirror device with improved usability capable of tracking a user's gaze to automatically face an LCD screen.

The present disclosure is to provide a digital rear mirror device with improved usability capable of capturing blind spots and approaching objects around a vehicle and outputting the captured blind spots and approaching objects on an LCD screen.

The present disclosure is to provide a digital rear mirror device with improved usability capable of expanding a user's driving field of vision by detecting the distance from an approaching vehicle to zoom out an image as the distance gets closer and zoom in an image as the distance gets farther.

The present disclosure provides a digital rear mirror device with improved usability capable of allowing a gaze tracking module to recognize motions of a user's gaze and pupil to automatically select some of a plurality of images output on an LCD screen and zoom in and out the images.

### Means for Solving the Problem

According to an aspect of the present disclosure, a digital rear mirror device with improved usability includes: a rear mirror display unit that is installed in an internal space of a vehicle and implements a mirror mode checking a rear space of the vehicle through reflection or refraction of light, and an LCD mode outputting an image or video; a sensor unit that that detects internal and external environments of the vehicle; a driving mode switching unit that selectively drives one of the mirror mode and the LCD mode; and a control unit that controls driving of the rear mirror display unit, in which the rear mirror display unit is controlled to track a user's gaze through the sensor unit so that a direction of a screen faces an area where a user is located.

The sensor unit may include: a driver's seat capturing module that captures a driver's seat among the internal spaces of the vehicle; and a gaze tracking module that extracts eyeball information of the user from an image collected from the driver's seat capturing module to track the user's gaze in real time, and the rear mirror display unit may be controlled to adjust a screen angle of the rear mirror display unit so that the direction of the screen faces an area where the user's eyeball is positioned in response to the user's gaze tracked through the gaze tracking module.

The driver's seat capturing module may include a driver's seat capturing camera and an infrared transceiver for transmitting and receiving infrared rays, and the gaze tracking module may be provided to extract a user's eyeball position from an image captured by the driver's seat capturing camera and then analyze an infrared reflection pattern of a user's pupil and cornea through optical modeling using the infrared transceiver to track the user's gaze.

The driving mode switching unit may include: a manual switching module that manually switches a driving mode of the rear mirror display unit by an user's operation; and an automatic switching module that is provided to automatically switch the driving mode of the rear mirror display unit based on environmental information received from the sensor unit, and the environmental information may include reverse detection information of the vehicle.

The sensor unit may include: a rear capturing module that captures the rear space of the vehicle; and a rear distance sensor that is installed at a rear or side rear of the vehicle, and the environmental information may further include approach information of adjacent objects toward the rear of the vehicle.

The rear distance sensor may include at least one or more selected from the group consisting of an ultrasonic sensor, a radar sensor, a LiDAR sensor, and a camera-based sensor, or a combination thereof.

The rear capturing module may include a first rear capturing camera that captures a left rear area of a rear area of the vehicle, a second rear capturing camera that captures a right rear area of the rear area of the vehicle, and a third rear capturing camera that captures a center rear area of the rear area of the vehicle.

The rear mirror display unit may be controlled to output a rear image captured based on relative positions where the first to third rear capturing cameras are installed while the LCD mode is driven.

The rear mirror display unit may be controlled to output an image captured from the first rear capturing camera at a lower left of the screen, an image captured from the second rear capturing camera at a lower right of the screen, and an image captured from the third rear capturing camera at a lower center of the screen while the LCD mode is driven.

The rear mirror display unit may be controlled to provide an image output on the screen by being zoomed in or out in response to an approach distance of the object measured by the rear distance sensor while the LCD mode is driven.

The rear mirror display unit may be controlled to zoom in and provide an image output on the screen when the object measured by the rear distance sensor is positioned within a preset approach distance while the LCD mode is driven, and to zoom out and provide the image as the approach distance of the measured object gradually gets closer.

The sensor unit may further include a front capturing module that captures a front space of the vehicle, and the environmental information may further include approach information of adjacent objects toward the front of the vehicle.

The digital rear mirror device with improved usability may further include a rear mirror rotation driving motor that adjusts a screen direction of the rear mirror display unit, in which the rear mirror display unit may be controlled to rotate horizontally and vertically through the rear mirror rotation driving motor so that the direction of the screen faces the area where the user is located.

The digital rear mirror device with improved usability may further include a rear mirror position adjustment driving motor that adjusts a position of the rear mirror display unit, in which the rear mirror display unit may be controlled to move horizontally and vertically through the rear mirror position adjustment driving motor so that the direction of the screen faces the area where the user is located.

The rear mirror display unit may be controlled to return to the mirror mode through the control unit when a gear operation of the vehicle is not checked within a preset time while the LCD mode is driven.

According to another aspect of the present disclosure, a digital rear mirror device with improved usability that includes a processor and a memory unit, and implements a mirror mode checking a condition behind a vehicle through reflected light and an LCD mode displaying an image and video, in which the digital rear mirror device further includes computer-executable instructions stored in the memory unit, and the computer-executable instructions cause the digital rear mirror device when executed by the processor of the device to perform the following operation of: receiving environmental information; switching a driving mode to an LCD mode; tracking a user's gaze; driving a driving motor; and rotating a rear mirror display. The environmental information is extracted from a sensor unit installed in the vehicle, and the sensor unit includes a driver's seat capturing module, a gaze tracking module, a rear capturing module, a rear distance sensor, and a front capturing module.

The driver's seat capturing module and the gaze tracking module may be provided to detect internal environmental information of the vehicle, and the rear capturing module, the rear distance sensor, and the front capturing module may be provided to detect external environmental information of the vehicle.

In the operation of receiving the environmental information, the external environmental information may be controlled to be input before the internal environmental information.

The external environmental information may include approach information related to a speed and size of an object adjacent to the vehicle, and gear shift information of the vehicle, and when the external environmental information is detected, the driving mode of the vehicle may be switched to the LCD mode and controlled to output a captured image of the front and rear of the vehicle.

According to still another aspect of the present disclosure, a digital rear mirror device with improved usability that includes a processor and a memory unit, and implements a mirror mode checking a condition behind a vehicle through reflected light and an LCD mode displaying an image and video, in which the digital rear mirror device further includes computer-executable instructions stored in a memory unit, and the computer-executable instructions, when executed by the processor of the device, cause the digital rear mirror device to perform the following operations: receiving a reverse signal of a vehicle; operating a rear distance sensor; detecting an object approaching a rear of the vehicle through the rear distance sensor; operating a rear capturing camera; and outputting an image captured by the rear capturing camera to a bottom of a rear mirror display.

The rear capturing camera may include a first rear capturing camera that captures a left rear area of a rear area of the vehicle, a second rear capturing camera that captures a right rear area of the rear area of the vehicle, and a third rear capturing camera that captures a center rear area of the rear area of the vehicle.

An image captured from the first rear capturing camera may be output at a lower left of the rear mirror display screen, an image captured from the second rear capturing camera may be output at a lower right of the rear mirror display screen, and an image captured from the third rear capturing camera may be output at a lower center of the rear mirror display screen while the LCD mode is driven.

### Effects of the Invention

According to the digital rear mirror device with improved usability according to exemplary embodiments of the present disclosure, by tracking the user's gaze to automatically move and rotate the LCD screen so that the direction of the LCD screen faces the user's gaze, it is possible to increase the convenience of the user while driving.

According to the digital rear mirror device with improved usability according to exemplary embodiments of the present disclosure, by checking the blind spots and the approaching objects around the vehicle with the recorded images in the LCD mode, it is possible to expand the user's field of vision and increase the accident prevention and safety.

According to the digital rear mirror device with improved usability according to exemplary embodiments of the present disclosure, by detecting the distance from the approaching vehicle to zooming out the image as the distance gets closer and zooming in the image as the distance gets farther, it is possible to effectively provide the user with the driving field of vision.

According to the digital rear mirror device with improved usability according to exemplary embodiments of the present disclosure, by allowing the gaze tracking module to recognize the motions of the user's gaze and pupil, it is possible to automatically select some of the plurality of images output on the LCD screen and zoom in and out the images.

### BRIEF DESCRIPTION OF THE DRAWING FIGURES

FIG. 1 is a configuration diagram for describing an interaction between internal components of a digital rear mirror device with improved usability according to exemplary embodiments of the present disclosure.

FIGS. 2(a) and 2(b) are diagrams for describing a direction according to a driving mode of a rear mirror display unit of the digital rear mirror device with improved usability according to exemplary embodiments of the present disclosure.

FIGS. 3(a) and 3(b) are diagrams for describing a rear capturing module and a front capturing module of the digital rear mirror device with improved usability according to exemplary embodiments of the present disclosure.

FIG. 4 is a diagram for describing an appearance that an image captured from the rear capturing module of the digital rear mirror device with improved usability according to exemplary embodiments of the present disclosure is output to the rear mirror display unit.

FIG. 5 is a flowchart for describing an LCD mode control sequence of the digital rear mirror device with improved usability according to exemplary embodiments of the present disclosure.

FIG. 6 is a flowchart for describing a control method of a rear capturing module of the digital rear mirror device with improved usability according to exemplary embodiments of the present disclosure.

FIG. 7 is a flowchart for describing a control method of a front capturing module of the digital rear mirror device with improved usability according to exemplary embodiments of the present disclosure.

FIG. 8 is a configuration diagram for describing a control unit system of a digital rear mirror device with improved usability according to exemplary embodiments of the present disclosure.

FIG. 9 is a block diagram illustrating a vehicle provided with a digital rear mirror device according to exemplary embodiments of the present disclosure.

FIG. 10 is a block diagram illustrating a control device of the vehicle of FIG. 9.

### DETAILED DESCRIPTION

Hereinafter, detailed embodiments of the present disclosure will be described. The following detailed descriptions are provided to help a comprehensive understanding of methods, devices and/or systems described herein. However, the embodiments are described by way of examples only and the present disclosure is not limited thereto.

In describing exemplary embodiments of the present disclosure, when it is decided that a detailed description of a well-known technology related to the present disclosure may unnecessarily obscure the gist of the present disclosure, the detailed description will be omitted. Further, the following terminologies are defined in consideration of the functions in the present disclosure and may be construed in different ways by the intention of users and operators. Therefore, the definitions thereof should be construed based on the contents throughout the specification. The terms used in the detailed description is merely for describing the embodiments of the present disclosure and should in no way be limited. Unless explicitly used otherwise, expressions in a singular form include the meaning in a plural form. In the present description, expressions such as “include” or “comprise” are used to refer to certain features, numbers, steps, operations, components, or some or a combination thereof, and should not be construed to preclude the presence or addition of one or more other features, numerals, steps, operations, components other than those described, or some or a combination thereof.

In addition, terms ‘first’, ‘second’, A, B, (a), (b), and the like, will be used in describing components of exemplary embodiments of the present disclosure. These terms are used only to differentiate the components from other components. Therefore, the nature, times, sequence, etc. of the corresponding components are not limited by these terms.

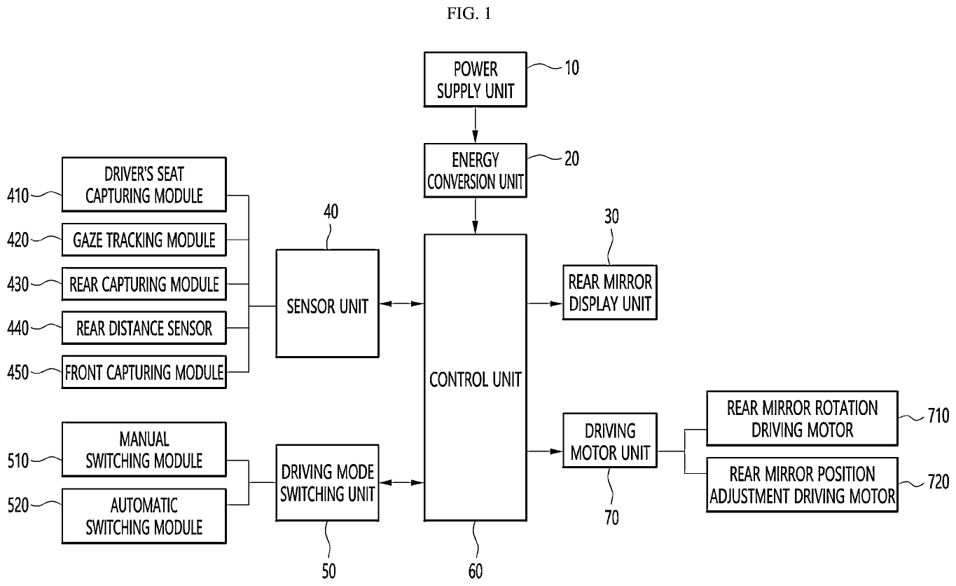

FIG. 1 is a configuration diagram for describing an interaction between internal components of a digital rear mirror device 1 with improved usability according to exemplary embodiments of the present disclosure.

Referring to FIG. 1, the digital rear mirror device 1 with improved usability includes a power supply unit 10 capable of supplying power, an energy conversion unit 20 capable of converting power supplied from the power supply unit 10, a rear mirror display unit 30 provided to enable implementation of a mirror mode and an LCD mode, a sensor unit 40 for detecting internal and external environments of a vehicle, a driving mode switching unit 50 for selectively driving one of the mirror mode and the LCD mode, a control unit 60 for controlling driving of the rear mirror display unit 30, and a driving motor unit 70 provided to rotate or move a position of the rear mirror display unit 30.

The power supply unit 10 may include a generator to generate power in order to charge a battery of the vehicle and operate electronic equipment inside the vehicle. The power supply unit 10 generates power as an AC, and therefore, may transmit the power to the energy conversion unit 20 and convert the power into a form of electricity that may be used in the vehicle.

The energy conversion unit 20 may include a regulator, a converter, etc., to convert AC power into DC power. The converted power is transmitted to the control unit 60, so the control unit 60 may control the rear mirror display unit 30, the sensor unit 40, the driving mode switching unit 50, and the driving motor unit 70.

The sensor unit 40 may include a driver's seat capturing module 410 for capturing the driver's seat among internal spaces of the vehicle, a gaze tracking module 420 for extracting the eyeball information of the user and tracking the user's gaze in real time, a rear capturing module 430 for capturing the rear area of the vehicle and providing the captured image, a rear distance sensor 440 capable of detecting objects or vehicles adjacent to the rear of the vehicle and measuring a distance therefrom, a front capturing module 450 for capturing a front area of the vehicle and providing the captured image.

The driving mode switching unit 50 may include a manual switching module 510 provided so that a driving mode of the rear mirror display unit 30 is manually switched by a user's operation, and an automatic switching module 520 provided so that the driving mode of the rear mirror display unit 30 is automatically switched based on environmental information received from the sensor unit 40.

In exemplary embodiments, the rear mirror display unit 30 may be maintained in a mirror mode in normal times, that is, in a general state where a mode switching signal to an LCD mode is not received, and may be switched from the mirror mode to the LCD mode only by the manual switching module 510 or the automatic switching module 520. In an embodiment, the switching from the mirror mode to the LCD mode may be performed only when the user switches the mode using the manual switching module 510, or when environmental information such as approaching object detection or a vehicle reverse signal is detected and the mode is automatically switched by the automatic switching module 520.

The manual switching module 510 may be provided, for example, as a switching lever or a switching button. When the user operates the switching lever or the switching button, the driving mode of the rear mirror display unit 30 may be switched from the mirror mode to the LCD mode, or from the LCD mode to the mirror mode. For example, for the convenience of front parking or when forward gaze is more important, the mode may be switched to the LCD mode so that the forward image is output according to the driver's settings.

The automatic switching module 520 may be provided to automatically switch the rear mirror display unit 30 to the LCD mode when receiving the environmental information from the sensor unit 40. The environmental information may include the detection of the vehicle reverse signal and the approach information such as a size and speed of adjacent objects toward the rear of the vehicle. In addition, the environmental information may further include the information on a size and approach speed of adjacent objects toward the front of the vehicle.

The control unit 60 may receive power from the power supply unit 10 and the energy conversion unit 20 to control the rear mirror display unit 30, the sensor unit 40, the driving mode switching unit 50, and the driving motor unit 70. The control unit 60 may synthesize information extracted by the driver's seat capturing module 410, the gaze tracking module 420, the rear capturing module 430, the rear distance sensor 440, and the front capturing module 450 of the sensor unit 40, and may switch the driving mode of the rear mirror display unit 30 in real time and rotate the rear mirror display unit 30 to face a position suitable for the user's gaze.

In an embodiment, the control unit 60 may control the driving mode switching unit 50 to switch from the mirror mode to the LCD mode when the sensor unit 40 detects an object approached from the front or rear of the vehicle.

The control unit 60 may extract information such as a user's sitting height, a pupil size, an angle, and a direction to designate the position of the rear mirror display unit 30 suitable for a user's gaze angle in order to provide the LCD mode suitable for the user. That is, the control unit 60 may control a rear mirror rotation driving motor 710 and a rear mirror position adjustment driving motor 720 of the driving motor unit 70, which will be described later, to adjust vertical and horizontal positions and an angle of the rear mirror display unit 30 so as to face the user's gaze, which will be described in detail later.

The driving motor unit 70 may include the rear mirror rotation driving motor 710 for adjusting a direction of the screen of the rear mirror display unit 30 and the rear mirror position adjustment driving motor 720 for adjusting the position of the rear mirror display unit 30.

The rear mirror rotation driving motor 710 may include a horizontal rotation motor and a vertical rotation motor so that the rear mirror display unit 30 may perform the horizontal and vertical rotations. The horizontal rotation motor may rotate the screen of the rear mirror display unit 30 left and right, and the vertical rotation motor may rotate the screen of the rear mirror display unit 30 up and down.

The rear mirror rotation driving motor 710 may rotate the direction of the rear mirror display unit 30 so that the direction of the screen of the rear mirror display unit 30 faces an area where the user is located based on the eyeball information of the user extracted through the gaze tracking module 420. In addition, when the mode of the rear mirror display unit 30 is switched to the mirror mode, the rear mirror display unit 30 may rotate in the forward direction, that is, in the previously set screen direction, so as to be projected into the rear space of the vehicle.

The rear mirror position adjustment driving motor 720 may include a horizontal movement motor and a vertical movement motor so that the rear mirror display unit 30 may move horizontally and vertically. The horizontal movement motor may move the screen of the rear mirror display unit 30 left and right, and the vertical movement motor may move the screen of the rear mirror display unit 30 up and down.

The rear mirror display unit 30 may be controlled to move horizontally and vertically through the rear mirror position adjustment driving motor 720 so that the direction of the screen faces the area where the user is located and the user's gaze. In exemplary embodiments, the rear mirror display unit 30 may be controlled by the control unit 60 to adjust the horizontal movement position and/or the vertical movement position of the rear mirror display unit 30 through the rear mirror position adjustment driving motor 720 based on the user's sitting height, the eyeball position, and the gaze angle extracted by the driver's seat capturing module 410 and the gaze tracking module 420.

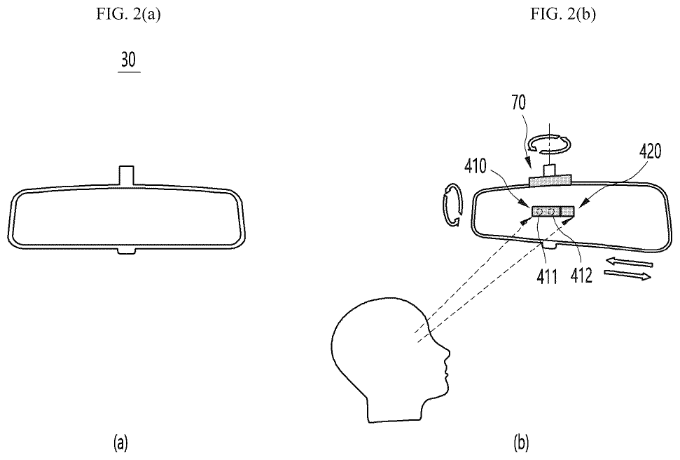

FIGS. 2(a) and 2(b) are diagrams for describing a direction according to the driving mode of the rear mirror display unit 30 of the digital rear mirror device 1 with improved usability according to exemplary embodiments of the present disclosure.

Referring to FIGS. 2(a) and 2(b), the rear mirror display unit 30 may be installed at the position where the user may check the rear of the vehicle. That is, the rear mirror display unit 30 may be installed in the front of the vehicle where the user's gaze may easily reach, more specifically, in the front center of the vehicle's internal ceiling, so that the user may easily look at the rear while driving.

The rear mirror display unit 30 may be provided so that the mirror mode that allows the rear space of the vehicle to be checked through the reflection or refraction of light, and the LCD mode that outputs the image or video, can be implemented.

The rear mirror display unit 30 may be provided with an LCD, and may be provided in the mirror mode in a normal state where no current flows, but when current flows, the LCD screen may be driven by the formation of a magnetic field, and an image of the rear or front of the vehicle may be output. The screen of the rear mirror display unit 30 is not limited to the above-described LCD, and may include any display screen on which the captured image may be output.

When the driving mode of the rear mirror display unit 30 is a mirror mode (a), the rear mirror display may be provided in a forward direction so as to illuminate the rear space of the vehicle, and when the driving mode is an LCD mode (b), the angle of the rear mirror display may be adjusted so that the rear mirror display faces the user so that the user may view the output image or video. In this case, the angle adjustment of the rear mirror display unit 30 may be performed by the rear mirror rotation driving motor 710.

In addition, when the driving mode of the rear mirror display unit 30 is the LCD mode (b), the position of the rear mirror display may be adjusted in the left-right direction or the up-down direction so that the user may view the output image or video more easily. In this case, the position adjustment of the rear mirror display unit 30 may be performed by the rear mirror position adjustment driving motor 720.

Meanwhile, the rear mirror display unit 30 may be controlled to return to the mirror mode if the gear operation of the vehicle is not checked within a preset time while the LCD mode is being driven through the control unit 60.

In an embodiment, the LCD mode may be automatically activated and the front image may be output to check the blind spots in front of the vehicle before the vehicle is driven after the user gets in and starts the vehicle, and then may return to the mirror mode after a certain period of time has passed. In another embodiment, the rear image may be automatically output after a preset period of time has passed since the LCD mode was driven. Meanwhile, when a reverse gear signal is input regardless of the driving mode of the rear mirror display unit 30, the rear image may be output immediately.

In addition, when it is difficult to normally output the captured image to the rear mirror display unit 30, such as the case where a problem occurs in the rear capturing module 430, the front capturing module 450, and the control unit 60, the state of the rear mirror display unit 30 may be automatically switched to the mirror mode.

The driver's seat capturing module 410 may be composed of a driver's seat capturing camera 411 and an infrared transceiver 412 for transmitting and receiving infrared rays. Specifically, the driver's seat capturing camera 411 may measure the user's sitting height to adjust the vertical position of the rear mirror display unit 30, and may specify the user's face area position as a bounding box to track and observe the user's body information.

The gaze tracking module 420 may be provided to track the user's gaze by extracting the user's face area and eyeball position from the image captured by the driver's seat capturing camera 411, and then analyzing the infrared reflection pattern of the user's pupil and cornea through the optical modeling using the infrared transceiver 412. In addition, the infrared transceiver 412 may detect heat of an object to be captured, so the positions of the user's face and pupil may be identified even in situations such as at night when there is no light.

As an example, the driver's seat capturing camera 411 may capture the driver's seat to specify an area corresponding to the user's face as the bounding box, and secondarily specify an area corresponding to the user's eyeball within the bounding box. The gaze tracking module 420 receives information on the second bounding box, checks the position of the user's eyeball, and extracts information such as the size, angle, and direction of the pupil in real time, thereby identifying and tracking the user's gaze. The rear mirror display unit 30 may adjust the screen angle so that the direction of the screen faces the area where the user's eyeball is positioned in response to the user's gaze tracked through the gaze tracking module 420.

In an embodiment, in the case of the LCD mode (b), the height of the screen of the rear mirror display unit 30 is adjusted by the rear mirror position adjustment driving motor 720 so that the screen faces the user's face area and gaze tracked by the driver's seat camera 411, the infrared transceiver 412, and the gaze tracking module 420, and the screen may rotate up and down and left and right to adjust the angle by the rear mirror rotation driving motor 710.

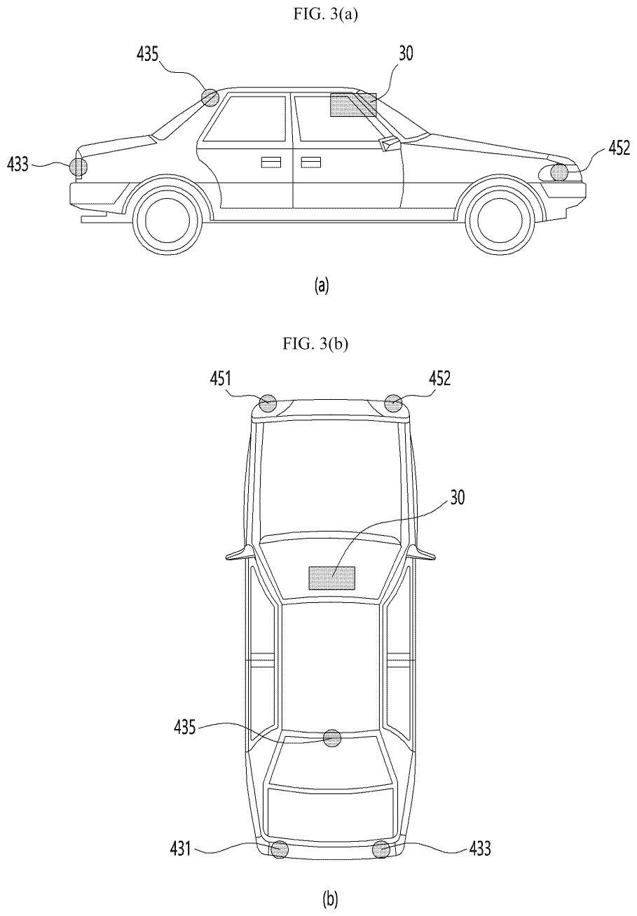

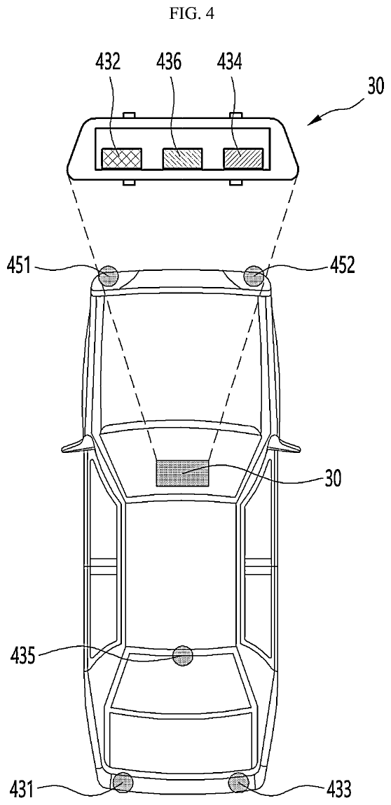

FIGS. 3(a) and 3(b) are diagrams for describing the rear capturing module 430 and the front capturing module 450 of the digital rear mirror device 1 with improved usability according to exemplary embodiments of the present disclosure, and FIG. 4 is a diagram for describing the appearance that the image captured by the rear capturing module 430 of the digital rear mirror device 1 with improved usability according to exemplary embodiments of the present disclosure is output to the rear mirror display unit 30.

The sensor unit 40 may include the rear capturing module 430 for capturing the rear space of the vehicle and the rear distance sensor 440 installed at the rear or side rear of the vehicle.

The rear distance sensor 440 may include at least one or more selected from the group consisting of an ultrasonic sensor, a radar sensor, a LiDAR sensor, and a camera-based sensor, or a combination thereof. The rear distance sensor 440 may measure a distance to an object detected at the rear of the vehicle, and may sound an alarm when the object approaches within a certain distance. For example, the rear distance sensor 440 may sound an alarm from a point where the approaching speed of the rear vehicle is at a certain speed or higher, or when the distance between the rear of the vehicle and the nearby object becomes 1 m.

The rear capturing module 430 may include a first rear capturing camera 431 for capturing a left rear area of the rear of the vehicle, a second rear capturing camera 433 for capturing a right rear area of the rear of the vehicle, and a third rear capturing camera 435 for capturing a center rear area of the rear of the vehicle.

In an embodiment, the first rear capturing camera 431 and the second rear capturing camera 433 may be installed at rear backlight positions on both sides of the vehicle, and the third rear capturing camera 435 may be positioned at a rear window, a rear spoiler, or a central trunk area of the vehicle. The installation positions and numbers of the rear capturing cameras are not limited to the above-described contents.

The rear mirror display unit 30 may be controlled to output the captured rear image based on the relative positions at which the first to third rear capturing cameras 431, 433, and 435 are installed while the LCD mode is driven.

Referring to FIGS. 3(a)-4 together, the rear mirror display unit 30 may be controlled so that, while the LCD mode is driven, the image captured by the first rear capturing camera 431 is output to the lower left of the screen, the image captured by the second rear capturing camera 433 is output to the lower right of the screen, and the image captured by the third rear capturing camera 435 is output to the lower center of the screen.

The image captured by the first rear capturing camera 431 may be provided as a first screen 432, the image captured by the second rear capturing camera 433 may be provided as a second screen 434, and the image captured by the third rear capturing camera 435 may be provided as a third screen 436.

Only one of the first screen 432, the second screen 434, and the third screen 436 may be selectively displayed on the rear mirror display unit 30, or these screens 432, 434, and 436 may be displayed simultaneously. For example, when an object approaching from the left rear is detected, only the first screen 432, which is the image captured by the first rear capturing camera 431, may be output, but when an object approaches from the rear front, the first to third rear cameras 431, 433, and 435 all capture images, so the first to third screens 432, 434, and 436 may be output simultaneously.

In addition, the rear mirror display unit 30 may be controlled to provide the image displayed on the screen by zooming in or out in response to the approach distance of the object measured by the rear distance sensor 440 while the LCD mode is driven.

In an embodiment, the rear mirror display unit 30 may be controlled to provide the image displayed on the screen by zooming in when the object measured by the rear distance sensor 440 is positioned within a preset approach distance while the LCD mode is driven, and to provide the image by zooming out as the approach distance of the measured object gradually gets closer.

Specifically, the rear distance sensor 440 may detect an object from the point where the distance between the vehicle and the object becomes 1 m, and the rear capturing camera closest to the position of the object may capture the object. For example, when an object approaches from the right rear of the vehicle, the second rear capturing camera 433 may start capturing the object, and the captured image may be output to the second screen 434. The rear capturing camera may start capturing by zooming in the detected object, and as the object approaches closer to the vehicle, the rear capturing camera may be zoomed out, so the image may change smoothly for the user to watch.

Meanwhile, the sensor unit 40 may include the front capturing module 450 for capturing the front space of the vehicle. The front capturing module 450 may capture the left and right blind spots in front of the vehicle to check the approach of an object that is not visible from the user's perspective.

Referring back to FIGS. 3(a) and 3(b), the front capturing module 450 may include a first front capturing camera 451 and a second front capturing camera 452, and the first front capturing camera 451 and the second front capturing camera 452 may be positioned on front lights on both sides of the front of the vehicle, a front radiator grille, a front windshield rain sensor cover, etc. The installation position and number of the front capturing cameras are not limited to the above-described contents.

In addition, referring together to FIGS. 3(a)-4, similarly to the above-described rear capturing module 430, while the LCD mode of the rear mirror display unit 30 is driven, the image captured by the first front capturing camera 451 may be output to the first screen 432, and the image captured by the second front capturing camera 452 may be output to the second screen 434. Only one of the first screen 432 and the second screen 434 may be selectively displayed on the rear mirror display unit 30, or the first screen 432 and the second screen 434 may be displayed simultaneously.

In another embodiment, while the LCD mode of the rear mirror display unit 30 is driven, the front image captured by the front capturing module 450 may be output to the upper portion of the screen of the rear mirror display unit 30, and the rear image captured by the rear capturing module 430 may be output to the lower end of the rear mirror display unit 30 screen.

For example, the image captured by the first front capturing camera 451 may be output to the upper left of the screen, the image captured by the second front capturing camera 452 may be output to the upper right of the screen, the image captured by the first rear capturing camera 431 may be output to the lower left of the screen, the image captured by the second rear capturing camera 433 may be output to the lower right of the screen, and the image captured by the third rear capturing camera 435 may be controlled to be output to the lower center of the screen.

In addition, the front image captured by the front capturing module 450 and the rear image captured by the rear capturing module 430 may be simultaneously output to the rear mirror display unit 30 screen.

Meanwhile, the rear mirror display unit 30 may be provided with a function capable of detecting a user's finger touch. A specific image among the front image and the rear image displayed on the rear mirror display unit 30 screen may be touched to be selectively viewed. In addition, by setting a finger touch motion, the specific image may be manually zoomed in or zoomed out for viewing.

In an embodiment, the user may touch the first screen 432 among the first to third screens 432, 434, and 436 displayed on the rear mirror display unit 30 to view only the image displayed on the first screen 432, and may additionally perform a preset finger touch motion to enlarge and view the first screen 432.

Meanwhile, the rear mirror display unit 30 may detect the user's gaze with the gaze tracking module 420 and select a specific image from among multiple front and rear images displayed on the screen. The gaze tracking module 420 may automatically select a specific image or zoom in or out an image by recognizing the motion of the user's eyes.

For example, the gaze tracking module 420 may automatically select a specific image from among multiple images displayed on the screen by recognizing an image on which the user's gaze remains for a certain period of time or a motion of blinking eyes, etc. In addition, by detecting changes in the size of the user's eyeballs and pupils, the user may set a motion to zoom in when the user opens his/her eyes wide, or zoom out when the user opens his/her eyes narrowly, or set a motion to zoom in when the user blinks his/her eyes twice and zoom out again when the user blinks his/her eyes twice again after a certain period of time. The contents regarding the motion recognition and setting time are not limited to the above-described contents.

In an embodiment, among the first to third screens 432, 434, and 436 output to the rear mirror display unit 30, the first screen 432 on which the user's gaze remains for a certain period of time may be automatically selected by tracking the user's gaze, and the first screen 432 may be enlarged by blinking the user's eyes twice.

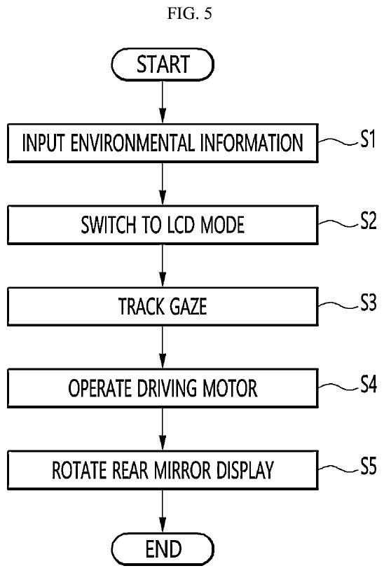

FIG. 5 is a flowchart for describing an LCD mode control method of the digital rear mirror device 1 with improved usability according to exemplary embodiments of the present disclosure.

Referring to FIG. 5, the LCD mode control sequence of the digital rear mirror device 1 with improved usability may proceed as an environmental information input step (S1), an LCD mode switching step (S2), a gaze tracking step (S3), a driving motor operation step (S4), and a rear mirror display rotation step (S5).

In the environmental information input step (S1), the vehicle's internal environmental information and external environmental information may be input to the control unit 60. The environmental information may be extracted from the sensor unit 40, and the sensor unit 40 may detect the vehicle's internal environmental information through the driver's seat capturing module 410 and the gaze tracking module 420, and may detect the vehicle's external environmental information through the rear capturing module 430, the rear distance sensor 440, and the front capturing module 450. In this case, when the external environmental information is detected and input first, the internal environmental information may be input later.

The LCD mode switching step (S2) may detect the external environmental information from the sensor unit 40, and cause the driving mode switching unit 50 to switch the rear mirror display unit 30 from the mirror mode to the LCD mode. The external environmental information includes the approach information such as the speed and size of an object approaching the front or rear of the vehicle, and may also include information on the user changing the gear of the vehicle. When the external environmental information is detected, the driving mode can be switched to the LCD mode, and front and rear captured images may be output.

The gaze tracking step (S3) may cause the sensor unit 40 to track the user's gaze. The sensor unit 40 may extract the eyeball information of the user and the gaze information in real time through the gaze tracking module 420, and based on the extracted information, may transmit information to the control unit 60 so that the direction of the screen output in the LCD mode faces the area where the user is located.

In the driving motor operation step (S4), the driving motor unit 70 may be driven so that the screen angle of the rear mirror display unit 30 may optimally face the user based on the user's gaze information extracted by the gaze tracking step. The driving motor unit 70 may control the rear mirror rotation driving motor 710 and the rear mirror position adjustment driving motor 720, and after the rear mirror position adjustment driving motor 720 is first controlled, the rear mirror rotation driving motor 710 may be controlled.

In the rear mirror display rotation step (S5), when the rear mirror position adjustment driving motor 720 adjusts the horizontal and vertical positions of the rear mirror display unit 30 to be suitable for the user's gaze, the rear mirror rotation driving motor 710 may be driven to rotate the rear mirror display unit 30 to an angle at which the rear mirror display unit 30 may face the user's gaze.

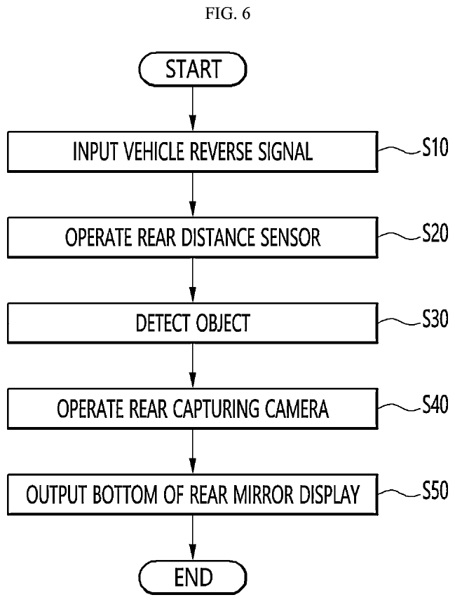

FIG. 6 is a flowchart for describing a control method of the rear capturing module 430 of the digital rear mirror device 1 with improved usability according to exemplary embodiments of the present disclosure.

Referring to FIG. 6, the control method of the rear capturing module 430 of the digital rear mirror device 1 with improved usability may proceed with a vehicle reverse signal input step (S10), a rear distance sensor operation step (S20), an object detection step (S30), a rear capturing camera operation step (S40), and a rear mirror display bottom output step (S50).

The vehicle reverse signal input step (S10) may check whether the gear of the vehicle is operated. When a user operates the vehicle in reverse gear, the control unit 60 may receive a reverse signal and control the rear distance sensor 440 of the sensor unit 40 to operate.

The rear distance sensor operation step (S20) and the object detection step (S30) may cause the rear distance sensor 440 to operate to detect the object approaching the rear of the vehicle. When the rear distance sensor 440 detects that the distance between the rear of the vehicle and the approaching object is within a certain distance, a signal may be input to the control unit 60 along with a warning sound. In an embodiment, a detection threshold of the rear distance sensor 440 may be set to 1 m, and when an object approaches within 1 m, the rear capturing camera may be operated.

In the rear capturing camera operation step (S40) and the rear mirror display bottom output step (S50), the LCD mode is driven along with the operation of the rear capturing camera and the captured image may be output. In an embodiment, when the distance from the object approaching from the right rear of the vehicle approaches within 1 m, the second rear capturing camera 433 may be operated along with the warning sound and may start capturing. The image captured by the second rear capturing camera 433 may be output to the second screen 434 at the lower right of the rear mirror display section 30, and the screen is zoomed in so that the user may easily check the approach of the object, and when the object approaches within 10 cm, the screen is gradually zoomed out and changes to a wide angle of view so that the user may easily check the rear condition.

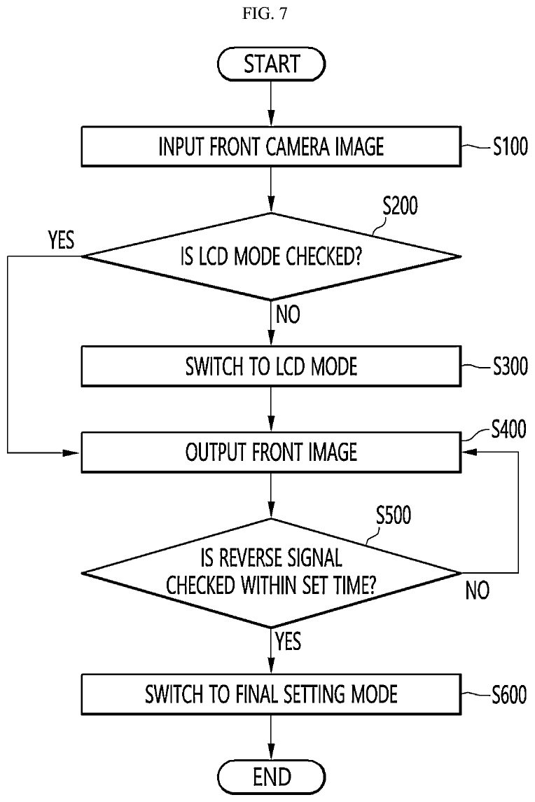

FIG. 7 is a flowchart for describing a control method of the front capturing module 450 of the digital rear mirror device 1 with improved usability according to exemplary embodiments of the present disclosure.

Referring to FIG. 7, the control method of the digital rear mirror device 1 with improved usability may be performed in the order of a front camera image input step (S100), an LCD mode check step (S200), an LCD mode switching step (S300), a front image output step (S400), a reverse signal check step within a set time (S500), and a final setting mode switching step (S600).

In the front camera image input step (S100), the front capturing module 450 may be automatically operated to detect a risk factor in the blind spot in front of the vehicle before the user starts driving after getting in the vehicle. In addition, the user may manually operate the front capturing module 450 to check the blind spot in front of the vehicle, if necessary.

The LCD mode check step (S200) may check whether the LCD mode for outputting the front capturing image to the rear mirror display unit 30 is driven by the control unit 60 when the front capturing module 450 is operated.

In the LCD mode switching step (S300), it may be checked whether the LCD mode is driven by the control unit 60 receiving a signal from the sensor unit 40, and when it is not switched to the LCD mode, the driving mode switching unit 50 may be controlled to switch to the LCD mode.

In the front image output step (S400), when the rear mirror display unit 30 is driven in the LCD mode, the front image of the vehicle may be output. In an embodiment, the image captured by the first front capturing camera 451 may be output to the first screen 432, and the image captured by the second front capturing camera 452 may be output to the second screen 434.

In the reverse signal check step within the set time (S500), it may be determined whether the front capturing image is continuously output based on the presence of the reverse gear signal within the preset time after the output of the front capturing image starts. In an embodiment, when the output of the front capturing image starts and the user does not operate the reverse gear for several seconds, the front capturing image may continue to be output. Depending on the user's settings, when the output of the front capturing image starts and the user does not operate the reverse gear for several seconds, it may be automatically switched to the mirror mode. On the other hand, when the user operates the reverse gear and the reverse signal is input, it may be switched to the final setting mode.

The final setting mode switching step (S600) may be set to either the mirror mode or the LCD mode. In an embodiment, when the reverse signal is input, the rear capturing image may be output to the rear mirror display unit 30. The rear mirror display unit 30 may output the rear capturing image and the front capturing image together, and may be switched to the mirror mode after the rear capturing image ends.

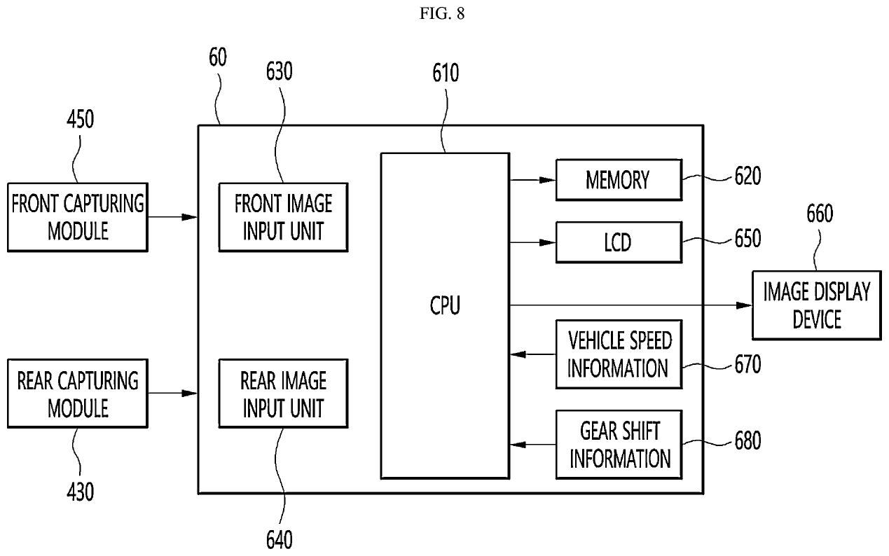

FIG. 8 is a configuration diagram for describing the control unit 60 system of the digital rear mirror device 1 with improved usability according to exemplary embodiments of the present disclosure.

Referring to FIG. 8, the control unit 60 may include a CPU 610, which is a central processing unit, a memory 620 that stores data processed by the CPU 610, a front image input unit 630 that receives images from the front capturing module 450, a rear image input unit 640 that receives images from the rear capturing module 430, an LCD 650, vehicle speed information 670, and gear shift information 680.

The front capturing module 450 and the rear capturing module 430 may transmit the images captured by the front image input unit 630 and the rear image input unit 640, respectively. The received images may be stored in the memory 620 through the CPU 610, which is the central processing unit, and may be transmitted to be output by the LCD 650 of the rear mirror display unit 30.

The control unit 60 may control the LCD 650 display to be driven when the rear mirror display unit 30 is switched to the LCD mode. Specifically, the control unit 60 may control a backlight that acts as a light source at a rear surface of the LCD 650, a color filter that may implement various colors of the screen, an electric signal, etc.

In addition, the control unit 60 may output an image material to an image display device 660 such as audio and navigation other than the LCD 650. For example, the rear capturing module 430 may capture the rear of the vehicle and the recognized sound and voice may be transmitted through the audio inside the vehicle.

Meanwhile, the control unit 60 may receive the vehicle speed information 670 and the gear shift information 680 and control the driving mode to be switched to the LCD mode by the driving mode switching unit 50. In an embodiment, the CPU 610 may process the vehicle speed information 670 and the information on a nearby object received from the rear distance sensor 440 together, automatically switch to the LCD mode, calculate whether there is a collision with the nearby object, and issue a warning. In addition, when the user operates a reverse gear to input the gear shift information 680, the LCD mode may be switched according to the rear capturing control method described above to output a rear image.

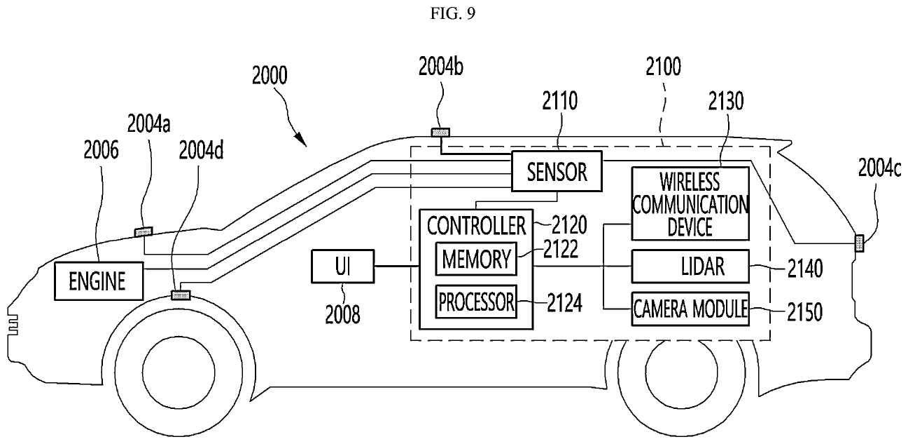

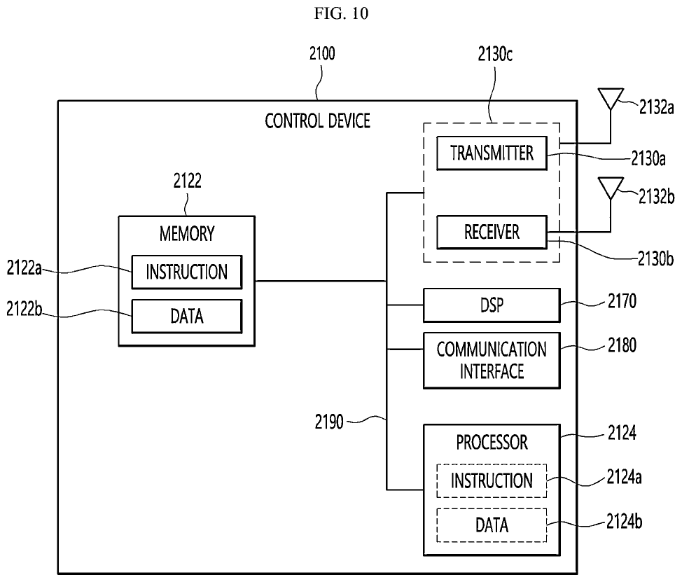

FIG. 9 is a block diagram illustrating a vehicle 2000 equipped with the digital rear mirror device 1 according to exemplary embodiments, and FIG. 10 is a block diagram illustrating a control device 2100 of the vehicle of FIG. 9.

Referring to FIGS. 9 and 10, a digital rear mirror system 100 according to various embodiments may be mounted on the vehicle 2000, and the vehicle 2000 may include the control device 2100. In this case, the vehicle 2000 may be an autonomous driving vehicle. In some embodiments, at least one component of a camera device 110 or at least one component of a digital rear mirror device 120 may be integrated into at least one component of the control device 2100.

The control device 2100 may include a controller 2120 including a memory 2122 and a processor 2124, a sensor 2110, a wireless communication device 2130, a LIDAR 2140, and a camera module 2150.

The controller 2120 may be configured by the manufacturer of the vehicle at the time of manufacture or may be additionally configured after manufacture to perform the function of the autonomous driving. Alternatively, a configuration for performing continuous additional functions may be included through an upgrade of the controller 2120 configured at the time of manufacturing.

The controller 2120 may transmit control signals to other components within the vehicle, such as a sensor 2110, an engine 2006, a user interface (UI) 2008, a wireless communication device 2130, a LIDAR 2140, and a camera module 2150. In addition, although not illustrated, the control signal may also be transmitted to an acceleration device, a braking system, a steering device, or a navigation device related to the traveling of the vehicle.

The controller 2120 may control the engine 2006, and for example, may detect a speed limit on a road on which the vehicle 2000 is driving and control the engine 2006 so that the driving speed does not exceed the speed limit, or control the engine 2006 to accelerate the driving speed of the vehicle 2000 within a range that does not exceed the speed limit. In addition, when sensing modules 2004a, 2004b, 2004c, and 2004d detect environment outside the vehicle and transmit the detected environment to the sensor 2110, the controller 2120 receives the environment and generates a signal to control the engine 2006 or the steering device (not illustrated) to control the driving of the vehicle.

The controller 2120 may control the engine 2006 or the braking system to decelerate the driving vehicle when there is another vehicle or an obstacle in front of the vehicle, and may control a trajectory, a driving path, and a steering angle in addition to the speed. Alternatively, the controller 2120 may generate a necessary control signal according to recognition information of other external environment such as a traveling lane marking or a traveling signal of the vehicle to control the traveling of the vehicle.

In addition to generating its own control signal, the controller 2120 can control the traveling of the vehicle by performing communication with the surrounding vehicle or the central server and transmitting a command for controlling the peripheral apparatuses through the received information.

In addition, when the position of the camera module 2150 is changed or the angle of view is changed, since it may be difficult to accurately recognize the vehicle or lane, to inhibit the problem, the controller 2120 may generate a control signal for controlling to perform the calibration of the camera module 2150. Accordingly, the controller 2120 may generate a calibration control signal to the camera module 2150 so that even if the mounting position of the camera module 2150 is changed due to vibration or shock generated according to the movement of the autonomous driving vehicle 2000, the normal mounting position, the direction, the angle of view, etc., of the camera module 2150 may be continuously maintained. The controller 2120 may generate the control signal to perform the calibration of the camera module 2150 when initial mounting position, direction, angle of view information, etc., of the camera module 2150 stored in advance and initial mounting position, direction, angle of view information, etc., of the camera module 2150 measured while the autonomous driving vehicle 2000 is driving vary by more than a threshold value.

The controller 2120 may include the memory 2122 and the processor 2124. The processor 2124 may execute software stored in the memory 2122 according to the control signal of the controller 2120. Specifically, the controller 2120 may store data and commands for securing a driving view of the vehicle 2000 in the memory 2122, and the commands may be executed by the processor 2124 to implement one or more of the methods disclosed herein.

In this case, the memory 2122 may be stored in a non-volatile storage medium executable by the processor 2124. The memory 2122 may store software and data through appropriate internal and external devices. The memory 2122 may include a random access memory (RAM), a read only memory (ROM), a hard disk, and a memory 2122 device connected to a dongle.

The memory 2122 may store at least an operating system (OS), a user application, and executable instructions. The memory 2122 may also store application data and array data structures.

The processor 2124 may be a controller, microcontroller, or state machine as a microprocessor or a suitable electronic processor.

The processor 2124 may be implemented in a combination of computing devices, and the computing device may be a digital signal processor, a microprocessor, or an appropriate combination thereof.

In addition, the control device 2100 may monitor characteristics of the interior and exterior of the vehicle 2000 and detect conditions using at least one sensor 2110.

The sensor 2110 may be composed of at least one sensing module 2004, and the sensing module 2004 may be implemented at a specific position in the vehicle 2000 depending on the purpose of detection. The sensor 2110 may be positioned at the bottom, rear, front, top, or side of the vehicle 2000, and may also be positioned on an internal component, tire, etc., of the vehicle.

By this configuration, the sensing module 2004 may detect information related to traveling such as the engine 2006, a tire, a steering angle, a speed, and a weight of a vehicle as the internal information of the vehicle. In addition, at least one sensing module 2004 may be configured as an acceleration sensor 2110, a gyroscope, an image sensor 2110, a RADAR, an ultrasonic sensor, a LiDAR sensor, and the like, and may detect movement information of the vehicle 2000.

The sensing module 2004 may receive, as external information, specific data on external environmental conditions such as state information, surrounding vehicle information, weather, and the like of a road on which the vehicle 2000 is located, and detect parameters of the vehicle accordingly. The detected information may be stored in the memory 2122 depending on the purpose, either temporarily or in the long term.

The sensor 2110 may collect and integrate information from the sensing modules 2004 for collecting the information that are generated inside and outside the vehicle 2000.

The control device 2100 may further include the wireless communication device 2130.

The wireless communication device 2130 is configured to implement wireless communication between vehicles 2000. For example, the vehicle 2000 may communicate with a user's mobile phone or other wireless communication devices 2130, another vehicle, a central device (traffic control device), a server, and the like. The wireless communication device 2130 may transmit and receive a wireless signal according to an access wireless protocol. The wireless communication protocol may be Wi-Fi, Bluetooth, long-term evolution (LTE), code division multiple access (CDMA), wideband code division multiple access (WCDMA), global systems for mobile communications (GSM), and the communication protocols are not limited thereto.

In addition, the vehicle 2000 may also implement vehicle-to-vehicle communication through the wireless communication device 2130. That is, the wireless communication device 2130 may communicate with other vehicles on the road through vehicle-to-vehicle communication. The vehicle 2000 may transmit and receive information such as driving warnings and traffic information through vehicle-to-vehicle communication, and may request or receive information to or from other vehicles. For example, the wireless communication device 2130 may perform V2V communication as a dedicated short-range communication (DSRC) device or a cell-V2V (C-V2V) device. In addition to the inter-vehicle communication, vehicle to everything communication (V2X) between the vehicle and other objects (for example, an electronic device carried by a pedestrian) may be implemented through the wireless communication device 2130.

In addition, the control device 2100 may include the LIDAR device 2140. The LIDAR device 2140 may detect an object around the vehicle 2000 during the operation using data sensed by the LIDAR sensor. The LIDAR device 2140 may transmit the detected information to the controller 2120, and the controller 2120 may operate the vehicle 2000 according to the detected information. For example, the controller 2120 may instruct a vehicle to reduce the speed through the engine 2006 when there is a forward vehicle traveling at a low speed in the detected information. Alternatively, the controller 2120 may instruct the vehicle to reduce the entry speed according to a curvature of a curve in which the vehicle enters.

The control device 2100 may further include the camera module 2150. The controller 2120 may extract object information from the external image photographed by the camera module 2150 and process information on the object information.

In addition, the control device 2100 may further include imaging devices for recognizing the external environment. In addition to the LIDAR 2140, a RADAR, a GPS device, an odometer, and other computer vision devices may be used, and these devices may be selected or simultaneously operated as needed to enable more precise detection.

The vehicle 2000 may further include the user interface 2008 for a user input to the control device 2100 described above. The user interface 2008 may allow a user to input information with appropriate interactions. For example, the user interface may be implemented as a touch screen, a keypad, an operation button, or the like. The user interface 2008 may transmit an input or a command to the controller 2120, and the controller 2120 may perform a control operation of the vehicle in response to the input or the command.

Additionally, the user interface 2008 may be configured to communicate with the vehicle 2000 via the wireless communication device 2130 as an external device to the vehicle 2000. For example, the user interface 2008 may be interoperable with a mobile phone, a tablet, or other computer devices.

Furthermore, although the vehicle 2000 is described as including the engine 2006, the vehicle 2000 may also include other types of propulsion systems. For example, the vehicle may be driven by electrical energy and may be operated by hydrogen energy or a hybrid system combining them. Accordingly, the controller 2120 may include a propulsion mechanism according to a propulsion system of the vehicle 2000, and may provide the control signal to components of each propulsion mechanism.

The control device 2100 includes the processor 2124. The processor 2124 may be a general purpose single or multi-chip microprocessor, a dedicated microprocessor, a microcontroller, a programmable gate array, or the like. The processor may be referred to as a central processing unit (CPU). In addition, the processor 2124 may be used as a combination of a plurality of processors.

The control device 2100 also includes the memory 2122. The memory 2122 may be any electronic component capable of storing electronic information. The memory 2122 may also be a combination of memories 2122 in addition to a single memory.

According to various embodiments, data and instructions 2122a for securing a driving view of a driver driving a vehicle 2000 may be stored in the memory 2122. When the processor 2124 executes the instructions 2122a, all or part of the instructions 2122a and data 2122b required for executing the instructions may be loaded onto the processor 2124 (2124a and 2124b).

The control device 2100 may include a transmitter 2130a, a receiver 2130b, or a transceiver 2130c to allow transmission and reception of signals. One or more antennas 2132a, 2132b may be electrically connected to the transmitter 2130a, the receiver 2130b, or each transceiver 2130c and may further include antennas.

The control device 2100 may include a digital signal processor (DSP) 2170. The DSP 2170 enables a vehicle to process digital signals quickly.

The control device 2100 may include a communication interface 2180. The communication interface 2180 may include one or more ports and/or communication modules for connecting other devices to the control device 2100. The communication interface 2180 may enable the user and the control device 2100 to interact.

Various configurations of the control device 2100 may be connected together by one or more buses 2190, and the buses 2190 may include a power bus, a control signal bus, a status signal bus, a data bus, and the like. Under the control of the processor 2124, the components may transmit information to each other through the bus 2190 and perform a desired function.

Although various embodiments of the present disclosure have been disclosed for illustrative purposes, those skilled in the art will appreciate that various modifications, additions and substitutions are possible, without departing from the scope and spirit of the invention as disclosed in the accompanying claims. Accordingly, the scope of the present disclosure is not construed as being limited to the described embodiments but is defined by the appended claims as well as equivalents thereto.

### DESCRIPTION OF REFERENCE NUMERALS IN THE DRAWINGS

1: Digital rear mirror device with improved usability
30: Rear mirror display unit
40: Sensor unit
50: Driving mode switching unit
60: Control unit
70: Driving motor unit
410: Driver's seat capturing module
411: Driver's seat capturing camera
412: Infrared transceiver
420: Gaze tracking module
430: Rear capturing module
431: First rear capturing camera
433: Second rear capturing camera
435: Third rear capturing camera
440: Rear distance sensor
450: Front capturing module
451: First front capturing camera
452: Second front capturing camera
710: Rear mirror rotation driving motor
720: Rear mirror position adjustment driving motor

1. A digital rear mirror device with improved usability, comprising:
a rear mirror display unit that is installed in an internal space of a vehicle and implements a mirror mode checking a rear space of the vehicle through reflection or refraction of light, and an LCD mode configured to output an image or video;
a sensor unit that detects internal and external environments of the vehicle;
a driving mode switching unit that selectively drives one of the mirror mode and the LCD mode; and
a control unit that controls driving of the rear mirror display unit,
wherein the rear mirror display unit is controlled to track a user's gaze through the sensor unit so that a direction of a screen faces an area where a user is located.

2. The digital rear mirror device with improved usability of claim 1, wherein the sensor unit includes:
a driver's seat capturing module that captures a driver's seat among the internal spaces of the vehicle; and
a gaze tracking module that extracts eyeball information of the user from an image collected from the driver's seat capturing module to track the user's gaze in real time, and
the rear mirror display unit is controlled to adjust a screen angle of the rear mirror display unit so that the direction of the screen faces an area where the user's eyeball is positioned in response to the user's gaze tracked through the gaze tracking module.

3. The digital rear mirror device with improved usability of claim 2, wherein the driver's seat capturing module includes a driver's seat capturing camera and an infrared transceiver for transmitting and receiving infrared rays, and
the gaze tracking module is provided to extract a user's eyeball position from an image captured by the driver's seat capturing camera and then analyze an infrared reflection pattern of a user's pupil and cornea through optical modeling using the infrared transceiver to track the user's gaze.

4. The digital rear mirror device with improved usability of claim 1, wherein the driving mode switching unit includes:
a manual switching module that manually switches a driving mode of the rear mirror display unit by a user's operation; and
an automatic switching module that is provided to automatically switch the driving mode of the rear mirror display unit based on environmental information received from the sensor unit,
wherein the environmental information includes reverse detection information of the vehicle.

5. The digital rear mirror device with improved usability of claim 4, wherein the sensor unit includes:
a rear capturing module that captures the rear space of the vehicle; and
a rear distance sensor that is installed at a rear or side rear of the vehicle, and
the environmental information further includes approach information of an adjacent object toward the rear of the vehicle.

6. The digital rear mirror device with improved usability of claim 5, wherein the rear distance sensor includes at least one or more selected from the group consisting of an ultrasonic sensor, a radar sensor, a LiDAR sensor, a camera-based sensor, and any combination thereof.

7. The digital rear mirror device with improved usability of claim 5, wherein the rear capturing module includes a first rear capturing camera that captures a left rear area of a rear area of the vehicle, a second rear capturing camera that captures a right rear area of the rear area of the vehicle, and a third rear capturing camera that captures a center rear area of the rear area of the vehicle.

8. The digital rear mirror device with improved usability of claim 7, wherein the rear mirror display unit is controlled to output a rear image captured based on relative positions where the first to third rear capturing cameras are installed while the LCD mode is driven.

9. The digital rear mirror device with improved usability of claim 8, wherein the rear mirror display unit is controlled to output an image captured from the first rear capturing camera at a lower left of the screen, an image captured from the second rear capturing camera at a lower right of the screen, and an image captured from the third rear capturing camera at a lower center of the screen while the LCD mode is driven.

10. The digital rear mirror device with improved usability of claim 5, wherein the rear mirror display unit is controlled to provide an image output on the screen by being zoomed in or out in response to an approach distance of the object measured by the rear distance sensor while the LCD mode is driven.

11. The digital rear mirror device with improved usability of claim 10, wherein the rear mirror display unit is controlled to zoom in and provide an image output on the screen when the object measured by the rear distance sensor is positioned within a preset approach distance while the LCD mode is driven, and to zoom out and provide the image as the approach distance of the measured object gradually gets closer.

12. The digital rear mirror device with improved usability of claim 5, wherein
the sensor unit further includes a front capturing module that captures a front space of the vehicle, and
the environmental information further includes approach information of an adjacent object toward a front of the vehicle.

13. The digital rear mirror device with improved usability of claim 1, further comprising:
a rear mirror rotation driving motor that adjusts a screen direction of the rear mirror display unit,
wherein the rear mirror display unit is controlled to rotate horizontally and vertically through the rear mirror rotation driving motor so that the direction of the screen faces the area where the user is located.

14. The digital rear mirror device with improved usability of claim 1, further comprising:
a rear mirror position driving motor that adjusts a position of the rear mirror display unit,
wherein the rear mirror display unit is controlled to move horizontally and vertically through the rear mirror position adjustment driving motor so that the direction of the screen faces the area where the user is located.

15. The digital rear mirror device with improved usability of claim 1, wherein
the rear mirror display unit is controlled to return to the mirror mode through the control unit when a gear operation of the vehicle is not checked within a preset time while the LCD mode is driven.

16. A digital rear mirror device with improved usability that includes a processor and a memory unit, and implements a mirror mode checking a condition behind a vehicle through reflected light and an LCD mode displaying an image and video, wherein the digital rear mirror device further includes computer-executable instructions stored in the memory unit, and the computer-executable instructions cause the digital rear mirror device when executed by the processor of the device to perform the following operations of:
receiving environmental information;
switching a driving mode to the LCD mode;
tracking a user's gaze;
driving a driving motor; and
rotating a rear mirror display, and
the environmental information is extracted from a sensor unit installed in the vehicle, and
the sensor unit includes a driver's seat capturing module, a gaze tracking module, a rear capturing module, a rear distance sensor, and a front capturing module.

17. The digital rear mirror device with improved usability of claim 16, wherein the driver's seat capturing module and the gaze tracking module are provided to detect internal environmental information of the vehicle, and
the rear capturing module, the rear distance sensor, and the front capturing module are provided to detect external environmental information of the vehicle.

18. The digital rear mirror device with improved usability of claim 17, wherein in the operation of receiving the environmental information, the external environmental information is controlled to be input before the internal environmental information.

19. The digital rear mirror device with improved usability of claim 17, wherein the external environmental information includes approach information related to a speed and size of an object adjacent to the vehicle, and gear shift information of the vehicle, and
when the external environmental information is detected, the driving mode of the vehicle is switched to the LCD mode and controlled to output captured images of the front and rear of the vehicle.

20. A digital rear mirror device with improved usability that includes a processor and a memory unit, and implements a mirror mode checking a condition behind a vehicle through reflected light and an LCD mode displaying an image and video, wherein the digital rear mirror device further includes computer-executable instructions stored in the memory unit, and the computer-executable instructions, when executed by the processor of the device, cause the digital rear mirror device to perform the following operations of:
receiving a reverse signal of the vehicle;
operating a rear distance sensor;
detecting an object approaching a rear of the vehicle through the rear distance sensor;
operating a rear capturing camera; and
outputting an image captured by the rear capturing camera to a bottom of a rear mirror display, and
the rear capturing camera includes a first rear capturing camera that captures a left rear area of a rear area of the vehicle, a second rear capturing camera that captures a right rear area of the rear area of the vehicle, and a third rear capturing camera that captures a center rear area of the rear area of the vehicle, and
an image captured from the first rear capturing camera is output at a lower left of the rear mirror display screen, an image captured from the second rear capturing camera is output at a lower right of the rear mirror display screen, and an image captured from the third rear capturing camera is output at a lower center of the rear mirror display screen while the LCD mode is driven.
